(19) United States
(12) Patent Application Publication
(10) Pub. No.: US 2021/0043045 A1
(43) Pub. Date: Feb. 11, 2021

(54) INTERACTIVE SYSTEM FOR FAN ENGAGEMENT WITH LIVE EVENTS

(71) Applicant: LiveFantasy LLC, Williston, ND (US)

(72) Inventor: David W. Noack, Williston, ND (US)

(21) Appl. No.: 16/989,099

(22) Filed: Aug. 10, 2020

Related U.S. Application Data
(60) Provisional application No. 62/884,476, filed on Aug. 8, 2019.

(51) Int. Cl. G07F 17/32; G06Q 50/34

(52) U.S. Cl. CPC G07F 17/3288; G06Q 50/34; G07F 17/323; G07F 17/3237

(57) ABSTRACT

There is disclosed a system for increasing engagement with live events. This system increases engagement by encouraging viewers to make predictions about each phase of an ongoing live event. Users may be rewarded with money, points, or with appearances on screen or on other displays as their preferred player or team is successful. Geographic limitations or other limitations may be imposed to ensure cheating is minimized, and to encourage a stadium-like atmosphere for users.

### RELATED APPLICATION INFORMATION

This patent claims priority from the following provisional patent applications:

U.S. provisional patent application No. 62/884,476 filed Aug. 8, 2019 and entitled REAL TIME SPORTS BETTING APPLICATION AND METHOD the entirety of which is incorporated by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

Field

This disclosure relates to live events and, more particularly, to a system for encouraging and rewarding fan involvement in live events.

### Description of the Related Art

Live events have often included viewer interaction. The most basic examples date to the 30s and 40s in radio, wherein broadcasters would solicit responses to trivia questions, run telephonic polls for plot development, or seek other responses from fans of radio programs. Over time, this evolved into shows like American Idol® where fans determine the winner of the show through call-in votes.

In a similar way, sports betting and so-called “prop” bets have been commonplace for years. Most of the betting related to those events pertains to the overall outcome of the game (e.g. a win or a loss for a particular participant or team), the score, or a “spread” in the final score. More esoteric betting, particularly in large scale events, includes bets on things such as the total length of the national anthem during the Super Bowl® or whether there will be a “wardrobe malfunction” during the halftime show. Political elections and other events have also become the subject of betting. “Fake” betting, where no money even changes hands, has also become popular.

Increasingly, so-called “fantasy” sports have become dramatically popular. Most sports leagues view these sports as powerful tools for increasing engagement for their leagues. This is because a given fantasy sports player often drafts team members for his or her fantasy team that are on different teams. That viewer, then, has an incentive to watch and root for players on multiple teams, rather than simply his or her “home team” on a given Sunday (for football) or other days for other professional sports.

In a somewhat related final turn of events, so-called “esports” have gained in popularity in the last five to ten years. Esports are generally sports that are played, typically in teams, using a video game. Popular esports presently include League of Legends®, Counter-Strike®, Valorant®, FIFA®, Madden®, and DOTA 2®; but esports come and go from time to time. Many games created in the last five years or so incorporate some element of multiplayer experience that is intended to be suitable for use or play as an esport. Some games are explicitly designed for this purpose. Esport viewers often watch on streaming services such as Twitch® or YouTube®. Like live sports, the leagues and game companies see this viewership as likely to increase game sales for that game and increase interest in the league itself. Both of those results generate more money for the players, game company and/or league (which are often co-owned in the case of esports).

All of these types of activities generally increase the interest of viewers or advertisers, or both, in a given sport. This interest benefits a given sport, league, or game developer. However, one shortcoming of all of these options is that these activities tend to focus on a final outcome or overall results of a given game or match. These activities are relatively passive while watching, thus allowing the viewer time to become distracted. In the case of viewers who increasingly hold sophisticated computers in the palms of their hand while watching a given league or game, distraction (e.g. from advertisers) is a significant concern. So, systems and methods for increasing the interactivity of a league or game throughout the course of a given event is a worthwhile goal.

### DESCRIPTION OF THE DRAWINGS

FIG. 1 is an overview of a system for increasing fan engagement with live events.

FIG. 2 is a block diagram of an exemplary computing device.

FIG. 3 is a functional block diagram of a system for increasing fan engagement with live events.

FIG. 4 is a flowchart of a process for increasing fan engagement with live events.

FIG. 5 is a flowchart of a process for capturing and transmitting audio and/or video from fans during a live event.

FIG. 6 is an example display screen of a mobile device showing play-by-play engagement for a given fan.

FIG. 7 is an example display screen of a mobile device showing statistics and other information helpful to a fan engaging with a live event.

FIG. 8 is an example display screen of a mobile device showing the results of a successful individual play prediction.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously described element having a reference designator with the same least significant digits.

### DETAILED DESCRIPTION

The present system increases fan engagement by enabling predictive interaction with ongoing live events throughout the live event. The types of events include sports and esports, but could also include other live events such as debates, concerts, or television programs. Throughout the live event, various sub-events occur. In baseball, there are individual pitches or hits. In football, there are first downs, yardage gained on downs, players being handed the ball (e.g. a running back or wide receiver) as well as outcomes of each of those actions (e.g. a 4 yard gain or a 2 yard loss). In esports, there are individual matches, towers to be captured, player kills to count, or other sub-goals to accomplish on the way to ultimate victory. In politics, there are statements to be made, sub-positions to be made clear, words that may or may not be said, or questions that may or may not be asked in a debate. Predictions may be made simply by making them using software. Or, in some cases, those predictions may be made using money, as in the case of online betting, with larger amounts wagered meaning that larger payouts are possible.

The present system enables ongoing predictions, and in at least some cases, bets to be placed, pertaining to each of these subparts of a given live event as it is taking place. The subparts may be minimally valuable individually, and a user may or may not participate in each subpart, but a given user can predict, as he or she desires, individual subparts of the given live event. As a result, each individual subpart can have more meaning and value to the user, and thus a user pays more attention as the live event proceeds.

To further encourage additional involvement by fans, when subparts of a given live event occur (e.g. a touchdown, a first down, a home run, a multi-kill, or other subparts) those users of the application that are more likely to be effected by that result may be identified and their microphones and/or cameras may be made active so that an associated fan “noise” may be heard and/or seen. For online events, such as esports, the event may incorporate moments for the involvement of this system, through pauses created for making predictions, or rely upon existing pauses (e.g. commercial breaks) to enable predictions to be made. For esports, pauses may be made within the software itself.

To avoid the potential for some viewers of a live event, such as those who are physically present at the live event, to profit through their knowledge of the event as it is happening, as opposed to a slight tape delay or stream delay that is the result of broadcast of the live event, those viewers may be separated digitally from other users. In such a way, there may be multiple pools of users that operate on different timing, since the subpart predictions by viewers must be made before the subpart occurs (e.g. before the play is run). And, rewards may be limited to those two groups, one set of rewards for the group present at the event, another for those not at the live event.

### Description of Apparatus

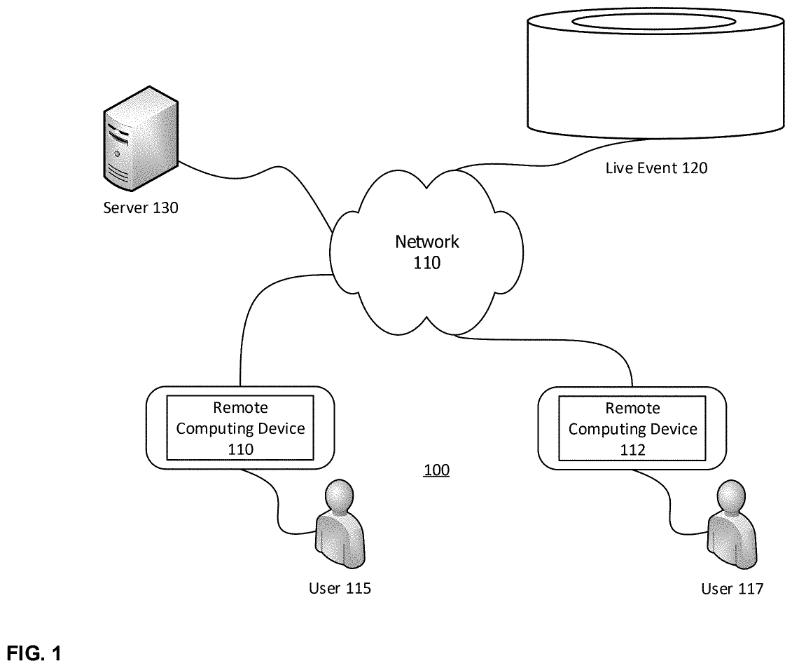

Referring now to FIG. 1, an overview of a system for increasing fan engagement with live events is shown. The system includes a series of remote computing devices 110 and 112, a live event 120, and a server 130, all interconnected via a network 110.

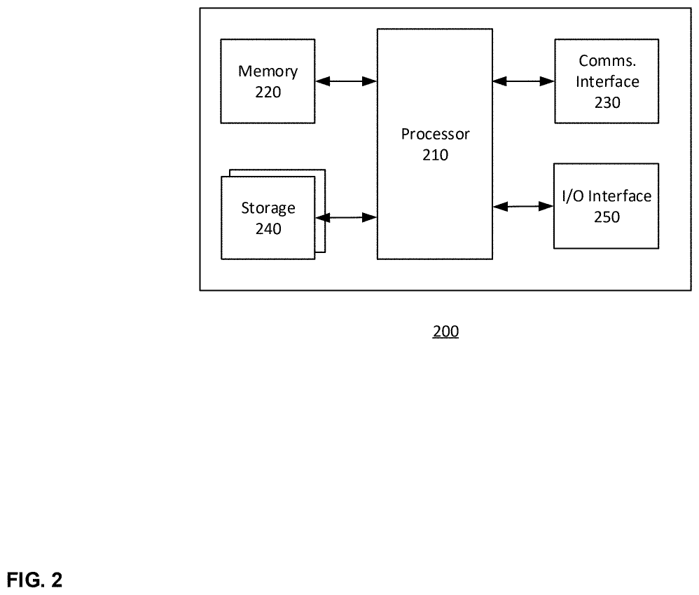

The remote computing devices 110 and 112 are computing devices (e.g., as shown in FIG. 2) operated by users 115 and 117. The users 115 and 117 are not a part of the system, but are shown merely to be representative of users operating the remote computing devices 110 and 112. Many potential users can participate using associated mobile devices at any time.

The remote computing devices 110 and 112 are used to view a display having an application suitable for viewing and/or interacting with the live event 120 on the remote computing devices 110 and 112. On-screen controls (e.g. capacitive or resistive on-display virtual buttons or joysticks) may operate as controls for the software. The remote computing devices 110 and 112 may also have microphones, cameras, speakers and/or the capability to integrate with headphones to provide sound from the live event 120.

The live event 120 may be virtually any kind of event that is live or, in theory, live-to-tape, to the extent that it can be confirmed that individuals participating in the system 100 cannot know the outcome of individual subparts of the live event. The words subpart or outcome, as used herein, mean a sub-event within the context of a live event. Examples of subparts or outcomes are individual pitches, individual plays, individual yardage gained, penalties imposed, scores made, or other quantifiable outcomes within the context of the live event, but not the ultimate outcome of the live event (e.g. a victory for a team or the final score or score differential).

The live event 120 shown represents quantifiable data and other information from an actual live event that is relevant to the system 100. The quantifiable data generally takes the form of statistics related to actual live events, or specific actions that occur within the context of actual live events.

The server 130 is a computing device (FIG. 2) that operates as a repository of the individual outcomes during the live event 120 and as the arbiter and orchestrator of predictions or selections made by users of the remote computing devices 110 and 112. The server 130 serves to identify individual remote computing devices 110 and 112 that are within geographic areas or meeting other criteria to capture microphone sounds and/or camera images in response to occurrences within the live event. The server can also track and store the ultimate database of all outcomes during the live event and across multiple live events to reward those who are successful in their predictions.

The server 130 may enable users to accumulate points across multiple events or subparts. Those points may be only points or may be or be representative of money won throughout an overall live event. And, at the end of an event, or series of events, the top scores may receive bonus prizes or may win additional sums of money as a result of their cumulative prediction accuracy. Likewise, groups of players, e.g. the fans of a particular team as opposed to the fans of the opposing team, may be rewarded if they are more-accurate predictors of outcomes as a group than the other fans.

The server 130 is shown as a single computer, but may be many computers spread across numerous locations. The server 130 may be one or more virtual servers, operating in the midst of a larger, physical server.

The network 110 is a communications medium for interconnecting the various components of the system 100. The network 110 may be or include the internet, wireless or wired networks, local or wide-area networks, and/or telephone networks. The network's primary purpose is to enable communication between the various components of the system 100 to be shared so that the overall experience can take place.

Turning now to FIG. 2, a block diagram of an exemplary computing device 200 is shown. As shown in FIG. 2, the computing device 200 includes a processor 210, a memory 220, a communications interface 230, along with storage 240, and an input/output interface 250. Some of these elements may or may not be present, depending on the implementation. Further, although these elements are shown independently of one another, each may, in some cases, be integrated into another.

The processor 210 may be or include one or more microprocessors, microcontrollers, digital signal processors, application specific integrated circuits (ASICs), or a systems-on-a-chip (SOCs). The memory 220 may include a combination of volatile and/or non-volatile memory including read-only memory (ROM), static, dynamic, and/or magnetoresistive random access memory (SRAM, DRM, MRAM, respectively), and nonvolatile writable memory such as flash memory.

The memory 220 may store software programs and routines for execution by the processor. These stored software programs may include an operating system software. The operating system may include functions to support the communications interface 230, such as protocol stacks, coding/decoding, compression/decompression, and encryption/decryption. The stored software programs may include an application or “app” to cause the computing device to perform portions of the processes and functions described herein. The word “memory”, as used herein, explicitly excludes propagating waveforms and transitory signals.

The communications interface 230 may include one or more wired interfaces (e.g. a universal serial bus (USB), high definition multimedia interface (HDMI)), one or more connectors for storage devices such as hard disk drives, flash drives, or proprietary storage solutions. The communications interface 230 may also include a cellular telephone network interface, a wireless local area network (LAN) interface, and/or a wireless personal area network (PAN) interface. A cellular telephone network interface may use one or more cellular data protocols. A wireless LAN interface may use the WiFi® wireless communication protocol or another wireless local area network protocol. A wireless PAN interface may use a limited-range wireless communication protocol such as Bluetooth®, WiFi®, ZigBee®, or some other public or proprietary wireless personal area network protocol. The cellular telephone network interface and/or the wireless LAN interface may be used to communicate with devices external to the computing device 200.

The communications interface 230 may include radio-frequency circuits, analog circuits, digital circuits, one or more antennas, and other hardware, firmware, and software necessary for communicating with external devices. The communications interface 230 may include one or more specialized processors to perform functions such as coding/decoding, compression/decompression, and encryption/decryption as necessary for communicating with external devices using selected communications protocols. The communications interface 230 may rely on the processor 210 to perform some or all of these function in whole or in part.

Storage 240 may be or include non-volatile memory such as hard disk drives, flash memory devices designed for long-term storage, writable media, and proprietary storage media, such as media designed for long-term storage of data. The word “storage”, as used herein, explicitly excludes propagating waveforms and transitory signals.

The input/output interface 250, may include a display and one or more input devices such as a touch screen, keypad, keyboard, stylus or other input devices.

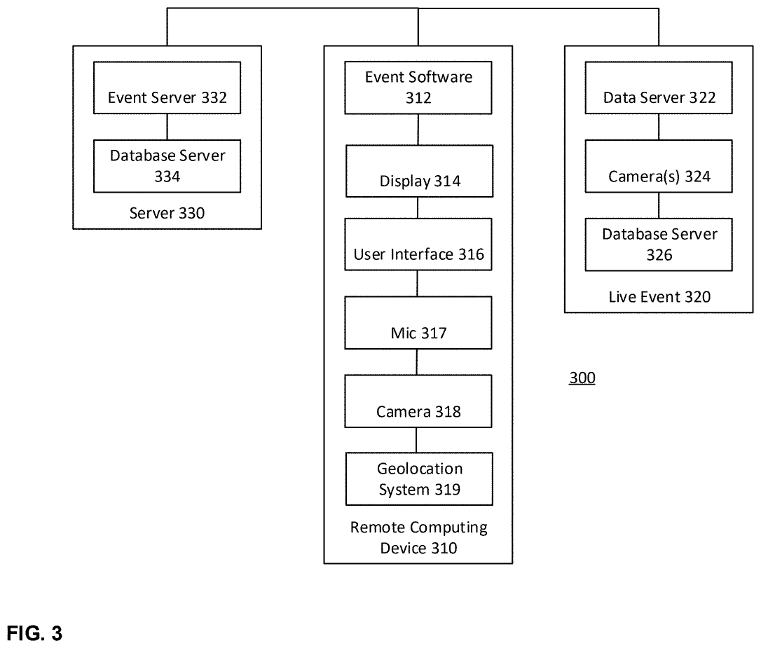

FIG. 3 is a functional block diagram of a system 300 for increasing fan engagement with live events. The system 300 includes a remote computing device 310, a live event 320, and a server 330.

The remote computing device 310 includes event software 312, a display 314, a user interface 316, a microphone 317, a camera 318, and a geolocation system 319. The components are shown functionally, and may be physically integrated into one another or physically separate from one another. Aspects of the functionality may be split across multiple physical components.

The remote computing device 310 may most commonly be a mobile device such as a mobile telephone or tablet computer. However, the functionality of the remote computing device 310 may be integrated into a desktop or laptop computer, a so-called “smart” television, a streaming device, or a purpose-built device for the functions described herein. Virtually any computing device is suitable, so long as it is capable of performing the functions described herein. The remote computing device 310 is shown alone, but in a typical case numerous remote computing devices will operate simultaneously for the same live event 320 and for other live events that may be taking place.

The event software 312 enables the remote computing device 310 to receive data pertaining to the live event 320, to display that data, and to accept, via a user interface 316, user selections predictive of outcomes within the live event. The event software 312 may be or include video that displays the live event (e.g. video streaming software or web-based “play-by-play” software) into which the other functionality is integrated. Alternatively, the event software 312 may be stand-alone software only for implementing the other functions described herein that is designed for use in conjunction with being physically present at a live event, or watching the live event on television or a separate streaming service. The event software 312 enables the remote computing device 310 to operate in conjunction with the server 330 to perform the other functions described herein.

The display 314 is a visual display for providing information to a viewer. Typically, the user interface 316 will be integrated into the display 314 as a touchscreen or other interface. However, in some cases, the user interface 316 may be separate from the display 314, being or including buttons, dials, analog sticks, toggles, or similar controls. The display 314 may be a typical mobile device or personal computer display that may simultaneously display content related to the live event 320 itself Alternatively, the display 314 may be a separate display from the live event 320 occurring in person near the individual user of the remote computing device 310 or separate from the individual's television or computer that is displaying the live event 320. The display 314 may be optional, as at least some of the functionality may operate using voice commands to a personal digital assistant like Siri®, Alexa® or Hey Google.

The microphone 317 is used for capturing audio created by a user (or their surroundings) of the remote computing device 310. The microphone 317 may be integrated, as it is in a typical mobile phone, tablet or laptop, or it may be separate as it is in many televisions. Alternatively, as discussed above, audio input may be drawn from separate speakers and/or microphones such as personal digital assistants.

The camera 318 is for capturing video of the area surrounding or in front of the remote computing device 310 and converting it to digital data that may be transmitted over a network to the server 330 and/or other remote computing devices. The camera 318, much like the microphone, maybe integrated into the remote computing device 310 or may be separate from it.

The geolocation system 319 is used to determine the location of the remote computing device. The most typical of these devices rely upon GPS (the global positioning system). Assisted GPS relies upon GPS in addition to available wireless networks and cellular networks, and data pertaining to signal strength. The geolocation system 319 may rely upon these types of location options, or may simply rely upon an internet protocol (IP) address and its general association with a particular region of the country and/or world. Large databases of wireless networks alone also can be used for geolocation.

The live event 320 is an ongoing event such as a football game, an esports competition, a live television program, a political debate, or other live event. However, the live event 320 itself is not actually a part of the system. The data generated from that live event 320 is. As such one or more camera(s) 324 may capture audio and video for that event that is streamed and/or broadcast to remote viewers, including those users of the remote computing device 310. There may also be remote computing devices that are physically present at the live event 320 such that the data generated by the camera(s) is largely unnecessary.

The data server 322 is software operating on a computing device at the live event 320 (or at a location in network communication with the live event 320) that receives input of live event data (e.g. the score, results of individual pitches, hits, in-game kills, touchdowns, player statistics and names, etc.) and stores that data in the database server 326 and that provides that data, as needed, to the server 330 and/or the remote computing device 310. For esports in particular, multiple locations may be necessary. So, multiple data server 322 may be required. Likewise, the database server 326 stores all data pertaining to the live event 320 as the event is going on and may transfer that data to the server 334 for longer term storage. The database server 326 is software operating on a computing device at the live event 320 (or a location in network communication with the live event 320) that stores data pertaining to the live event 320.

The server 330 includes an event server 332 which is software operating on the server 330 that manages the receipt of updated event data relating to an ongoing live event. The event server 332 also operates to transmit and receive selection and status information with remote computing devices 310 (and other remote computing devices) related to the ongoing live event 320. The even server 332 operates as an orchestrator of all of the live event 320 data and the receipt of predictive selections from remote computing devices, and the reward of those who succeed in those predictions. To the extent that points or money are involved in the predictions, the event server 332 can act as a point/payment processor or work with payment processing systems to complete the exchange of points and/or money.

The database server 334 is software operating on the server 330 that stores event data related to the live event 320 and provided by the data server 322 and predictions and other interactions and settings set by remote computing devices, like remote computing device 310. The database server 334 may operate to store data pertaining to many live events at once, or over the course of weeks or years. The same server 330 may simultaneously serve numerous ongoing live events.

### Description of Processes

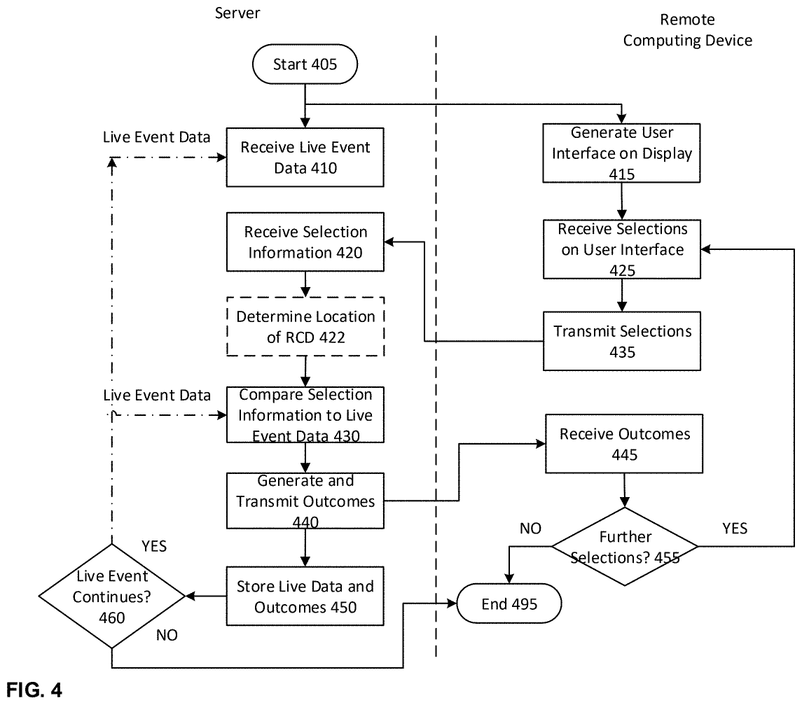

Referring now to FIG. 4, a flowchart of a process for increasing fan engagement with live events is shown. The flowchart has a start 405 and an end 495, but may continue indefinitely so long as a given live event is occurring. Likewise, the flowchart may operate independently for each individual remote computing device and for each live event.

First, the server receives live event data at 410. This live event data may be generated, for example, by the data server 322 (FIG. 3) at or associated with a live event. The live event data may include the major events, ends of quarters, ends of rounds, scores, overall scores, individual plays, kills-to-deaths ratios, outcomes of the overall live event. However, the live event data also includes a number of subparts or outcomes. These may be movements of players around the field of play, individual pitches, individual plays on a field, or movement of a ball or other play a certain distance or through certain milestones. Any number of outcomes may be generated as a part of this live event data.

This live event data is updated as quickly as reasonably feasible in response to its occurrence during the live event. The data server 322 may be fed by or be an automated computer that generates event data. Alternatively, the data server 322 may be fed by an individual who is responsible for indicating if a given pitch is a strike, a hit is a home run, a passing play is for 10 or 12 yards, etc. In some cases, particularly cases of esports, the data is generated automatically by the game itself as the live event takes place.

That data is received at 410 on an ongoing basis as each pitch comes in, as each play is made, or as each step in the overall process of the live event takes place. This may be aided by the game itself. For example, esports games can have built-in pause functions in some cases. During these pauses, the remainder of this process may play out. Baseball, for example, has significant downtime between pitches and batters. Likewise, football plays, in many cases, take several seconds between a whistle dead for one play and the start of the next play or when the football changes to a team from another team. Games like Madden® football incorporate the ability to pause at virtually any time. So, live event data may be received on an ongoing basis, but it also may have built-in pauses in that data to enable predictions to be made or for commercial breaks.

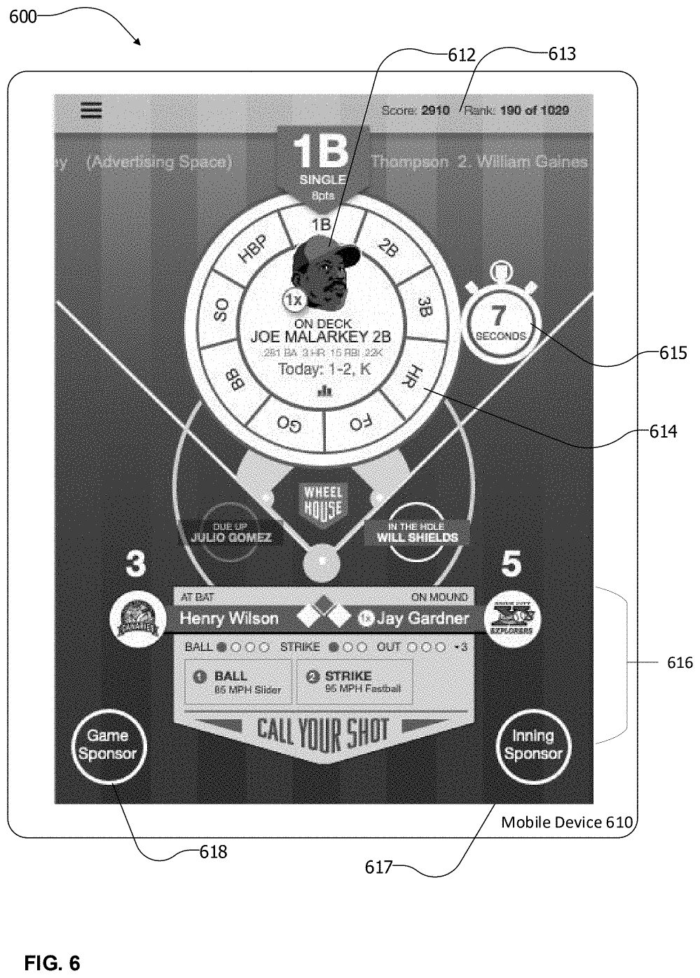

At the same time that live event data is received, any number of remote computing devices may generate user interfaces on their respective displays. Those user interfaces may differ for each individual live event type, primarily because the substance of those live events differ. Some examples of screens suitable for a baseball game are provided as FIGS. 6-8. The user interfaces each allow for an individual user to make predictive selections. As indicated above, these may be for a given pitch to result in a strike, or a ball. They may be for a given play to be a running play or a passing play. They may be for a particular fort to be captured in an online esport. Given that the user is interacting with the screen throughout the live event, the user interface 415 provides an opportunity to present advertisements which may also be visible on that user interface.

The user may interact with the user interface on the display to access statistics related to the team, the player, or the ongoing live event. These statistics may enable a user to make a better educated guess as to the outcome of a given subpart. For example, if a given player of an esport (e.g. Madden®) often runs a running play on second down, then that may be reflected in the historical statistics available to a person attempting to predict the outcome of the next play that same player runs in Madden®.

The user remote computing device may receive the predictive selections from the user using the user interface at 425. At this stage, the user selects what he or she expects the outcome of the next play to be, or the results of the next match, or any number of outcomes to take place in the short term. This is generally not the overall outcome of the game, match or play. These are individual subparts along the way to an overall outcome. At the outset, a user may make a prediction as to the outcome, but the purpose is, at least in part, to maintain interest in the ongoing event during the course of the event. So, the prediction received at 425 will generally be for a subpart of the live event.

The selections made are then transmitted to the server at 435. In many cases, those selections must be completed a predetermined amount of time before the event occurs (e.g. a pitch or a play in Madden®). A timer may be used to count down to the deadline for submitting the predictive selections. Once made, the selections for each user may be transmitted to the server at 435.

Those selections may be received by the server at 420. Numerous selections from many, many players may be received at the same server substantially simultaneously, but for purposes of this description, only the one from the remote computing device is considered. That selection will indicate the expected outcome of the next event (e.g. a pitch or a play).

The server may, optionally, determine the location of the remote computing device making a given selection at 422. This may be used for multiple purposes. For example, it may be used to ensure that the user of the remote computing device is not cheating by being at the live event. As should be well known, live events are broadcast with short term delays to allow broadcasters opportunity to “bleep” unsavory language during prime time viewing or accidental streakers and the like. Similarly, streaming services inevitably take time to encode, transmit, broadcast, then decode at a given device, the content being streamed. Both of these create lags of “live” events on the order of 2 to 40 seconds, depending on what is done to the broadcast or stream.

In this context, an individual physically present at an event may have a significant advantage of knowing what actually did occur before at-home viewers. So, knowing that a given user is within the nearby area of the live event may mean they should be excluded from predicting, or may simply require a different timeline (e.g. faster) for making their predictions before they are accepted. That process may be done at 422.

The live event may continue on schedule, and the selections made by the user of the remote computing device may be compared at 430 to determine whether the predictions were correct. This comparison may be between data generated by the event server 322 and the selections made at 425. As indicated above, these selections may be any number of subparts of an overall live event. These may be which player gets the ball on a given play, which player has the winning capture of a fort in an esport, which player survives the next two minutes in an esport, or the outcome of a particular volley or serve in a tennis match.

Next, the outcomes (e.g. whether the predictions were correct, or not) are generated based upon this comparison and transmitted to the associated remote computing device at 440. If there were wagers associated with this prediction, and if there were any multipliers available for selecting a particularly unlikely outcome, that may be a part of the outcome that is generated and transmitted to the remote computing device.

Those outcomes are received at 445. That receipt may include display of the outcome (e.g. “You Win!”) on the display of the remote computing device. The outcome may further include receipt of points and/or monetary winnings that are reflected on the display as well.

Substantially simultaneously, the results of those outcomes for that particular user may be stored alongside the received live event data at 450 in the database server 334. This may be for purposes of maintaining a historical record, and for purposes of generating an overall points accumulation or monetary payment owed at the end of a given live event for a user of a remote computing device.

Next, the user of the remote computing device may be presented with the opportunity to make further selections (e.g. predict future pitches or plays) at 455. This way, the user's involvement in the live event may be maintained throughout the event. If the user makes no further selections (“no” at 455), then the process ends at 495. If the user does make further selections (“yes” at 455), then the process continues at 425.

Substantially simultaneously, the server determines if the live event itself is continuing at 460. If not (“no” at 460), then the process ends at 495. If so, then still more live event data is received at 410 and the process continues.

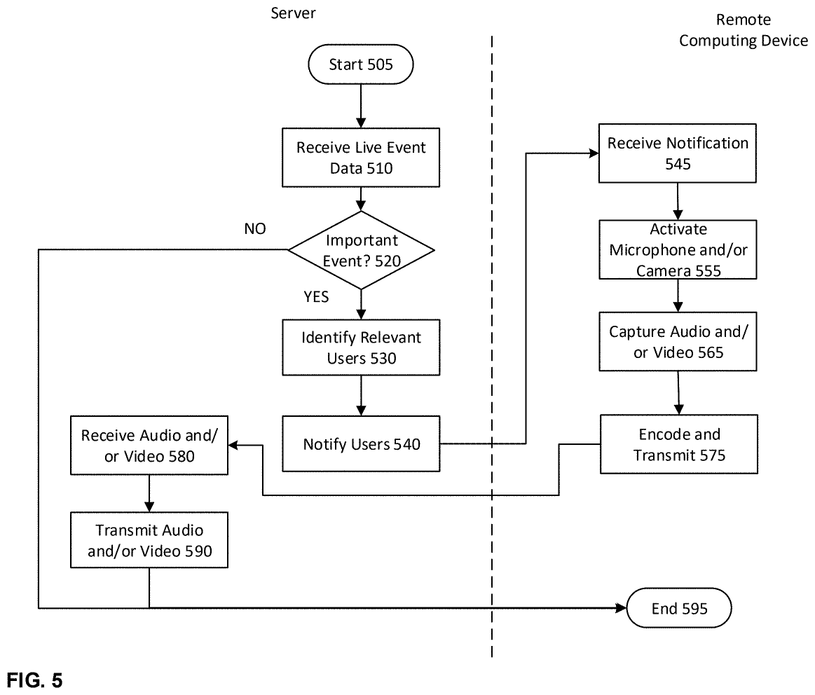

FIG. 5 is a flowchart of a process for capturing and transmitting audio and/or video from fans during a live event. The flowchart has a start 505 and an end 595, but may take place substantially simultaneously for any number of remote computing devices. Alternatively, it may purposefully be limited to only a select few remote computing devices.

Following the start at 505, live event data is received at 510. This may be a part of the overall process of FIG. 4, so that the data may identify a given play, pitch, match, or subpart of any live event. However, at 520, an important event is identified. The meaning of an important event may vary for each sport, event, esport, or other live event. For a baseball game, a home run would likely be an important event. Even a hit may be an important event in many cases. In an esport, a kill of a player may be an important event or a capture of a key point in the map or game may be. For football, or an esport involving a simulation of football, a touchdown or field goal or even a particularly long passing play or running play (e.g. greater than 30 yards) may be an important event. These types of events may be pre-determined using a database to automatically flag events meeting certain criteria, or they may be determined at least in part by a human viewer identifying a particular event as important. If an event is not important (“no” at 520), then this process ends at 595.

Once an event is identified as important (“yes” at 520), then relevant users may be identified at 530. This process may take a few different forms. The most basic option is to identify those users of remote computing devices that are within a certain geographical area. As a general rule, at least for traditional city-based professional sports, viewers of a given sport within that city are much more likely to be supporters of the local team. So, for example, individuals in Chicago are more likely to support the Chicago Bears® professional football team. So, the server may use a geolocation system to determine which (or a subset of which) users of the remote computing devices are within 400 miles of the city of Chicago. Those users are likely to be supporters of Chicago if the important event is a score of the Chicago Bears®.

Alternatively, relevant users may be identified at 530 based upon (or in part upon) self-identified characteristics (e.g. a favorite team list in a setting within the software) or a location set within the software, or in the credit card billing information associated with the software. Alternatively, a user may be identified by GPS or similar systems operating on the remote computing device as discussed above. That information may be saved on the server for specifically this purpose.

Still further alternatively, relevant users may be identified at 530 based upon a challenge or payment of money to appear a part of the relevant users. The challenge may be to complete a certain task, including a number of consecutive or total correct predictions over a game, a season, a match, or other metric. Alternatively, a user may elect to donate 3000 points or $3 to a cause or simply to pay to have themselves considered a relevant user. The number of relevant users, in most cases, may be purposefully limited to a few tens or few hundred people. In other examples, entire stadiums may be a part of the relevant users (perhaps using a single microphone and/or camera).

Those relevant users that are identified are notified at 540. This notification tells the selected remote computing devices that they have been selected for audio and/or video capture.

This notification is received at 545. This notification may be explicit, meaning a popup on the display, with a confirmation that it is accepted, or may be implicit, taking place in the background without any user interaction required. Alternatively, the user may have selected previously to have this process take place without any interaction required.

Thereafter, the microphone and/or camera is activated at 555. The point of this process is to capture audio and/or video related to the excitement of a fan watching an important play from his or her preferred team. If numerous fans are captured at the same time, it may embody a bit of the experience of being in a stadium with all fans cheering at the same time. If only one or a few fans are selected, then each may say some encouraging words to other fans or the team on video or on the microphone in response to a big play. That audio and video may also be played on a jumbotron or similar display and audio systems of stadiums.

That audio and/or video may be captured by the remote computing device at 565. Mobile devices are particularly good at this, effectively taking a selfie video or audio note of the user. Other remote computing devices likewise can capture audio and video in much the same way.

The audio and/or video may then be encoded and transmitted at 575. This involves the encoding and transmission of the audio and/or video to the server for storage and/or rebroadcast/restream to others. This process may be substantially in real-time so that it can be heard as the important event takes place or shortly thereafter to increase the excitement.

The audio and/or video is received at 580 at the server. It may be reviewed to ensure that it is appropriate and not profane, but otherwise may then be transmitted at 590 to other users of the software on their remote computing devices. The audio and/or video may also be sent to jumbotrons or to television broadcasts or internet streams to be included along with those as they are sent out.

The process then ends at 595.

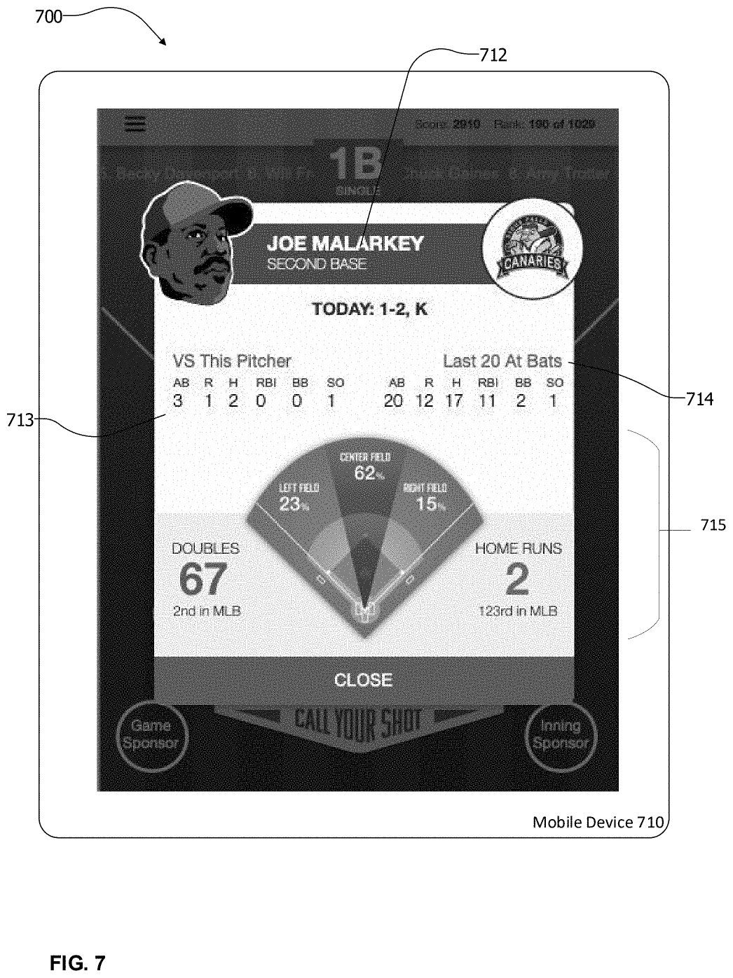

FIG. 6 is an example display screen 600 of a mobile device 610 showing play-by-play engagement for a given fan. The display screen 600 has a player 612 identified, a Joe Malarkey, and certain information about Joe including his prior at bats during the day. A user can select Joe Malarkey and be presented with more detailed information (shown in FIG. 7 below) related to Mr. Malarkey.

An overall score 613 for a user, as well as their respective rank among others watching the live event may be shown as well.

As indicated above, the user may select the expected outcome of this at-bat for Joe Malarkey. Here, for baseball, a rotary wheel 614 is shown with options such as 1B (meaning a single), 2B (meaning a double), HR (meaning a home run), and SO (meaning a strike out) is shown. The user may select one of these outcomes. Other interfaces may be used for different scenarios, different sports, and different live events. A counter 615, counting down to a deadline to enter a predicted outcome may be used as games move on in real time.

Additional information 616, including statistics like the current state of the game as a whole may be shown elsewhere on the display.

Likewise, spaces 617, 618 for advertisement are available.

FIG. 7 is an example display screen 700 of a mobile device 710 showing statistics and other information helpful to a fan engaging with a live event. Here, the display after selecting Mr. Malarkey in the prior figure is shown. Here, the user may see Mr. Malarky 712 again. Statistics related to this particular pitcher 713 are shown along with Mr. Malarkey's last 20 at bats at 714. Additional information 715 about ball placement when hits occur and how likely this player is to have a double or a home run may also appear. For other sports, epsorts, or live events, different statistics may be available. The point of these additional stats is to increase engagement, but also to enable users to make more-educated predictions about the course of the game.

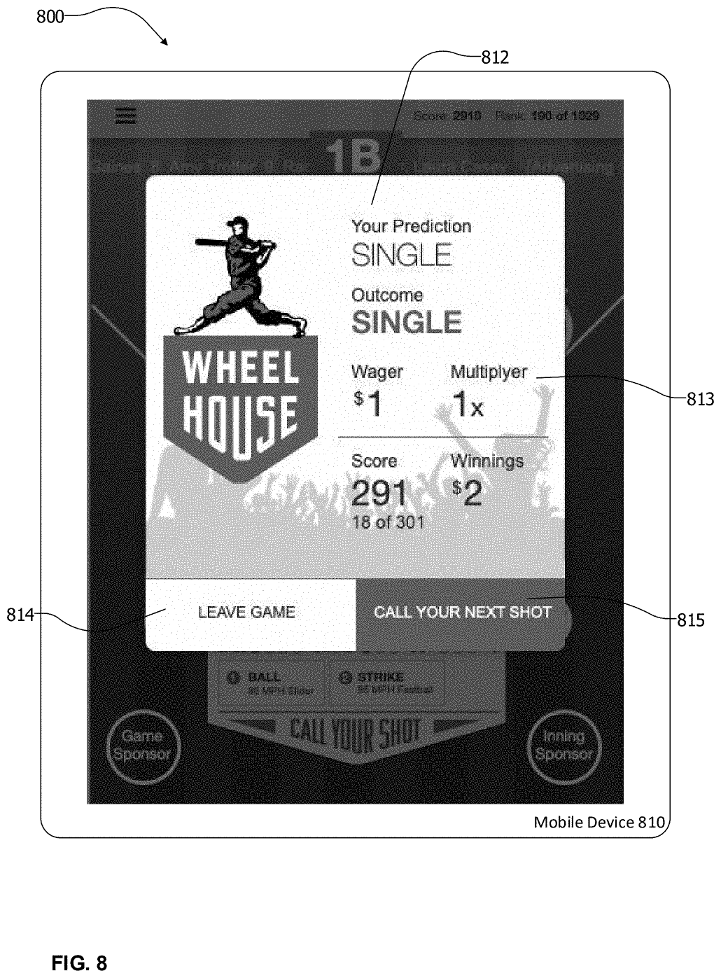

FIG. 8 is an example display screen 800 of a mobile device 810 showing the results of a successful individual play prediction. Here, a user predicted that Mr. Malarkey would have a base hit (a single) shown at 812. Mr. Malarkey has done so. The outcome results 813 are shown. Here, the individual's wager (if this event were for live betting) is shown as a single dollar. There is no multiplier on a single for this player—though there may be for certain players and predictive outcomes as discussed above—so it is merely a lx multiplier. The overall score is shown along with winnings.

As a given live event completes, or as it proceeds, a user's cumulative score may be kept and displayed on this screen 800 or one much like it. Due to payment processing systems charging for use, it may be more economical to tally points throughout an event and to complete one transaction once the live event is complete to provide a player with his or her winnings or to receive payments for losses (or merely tally those payments and deduct them from a pre-existing funded account).

The user may be presented with the opportunity to leave the game 814 or to continue playing at 815. As indicated above, the interfaces may vary from sport, to live event, to esport, or other event. However, the overall process is much the same.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system for interactive fan engagement with live events comprising:
a server, including a first processor and first non-volatile memory, comprising:
a communications interface for receiving updated event data relating to an ongoing live event and for transmitting and receiving selection and status information with remote computing devices related to the ongoing live event;
a database for storing the updated event data; and
the first processor having software which when executed by the first processor compares the selection and status information with the updated event data to identify correct selections that occurred prior to a corresponding portion of the updated event data and to identify user accounts associated with the correct selections.

2. The system of claim 1 further comprising:
a remote computing device, including a second processor and second non-volatile memory, separate from the server, comprising:
a display for displaying the status information for the ongoing live event as received from the server;
a user interface for receiving selection information from a user identifying an expected outcome relating to the ongoing live event; and
a second communications interface for transmitting the selection information to the server and for receiving status information identifying the correct selections as associated with a user account associated with the user.

3. The system of claim 2 wherein the second processor has software which when executed by the processor will cause the processor to receive the selection from the user using the user interface and update the display with an indication of a correct selection upon receipt of the status information from the server.

4. The system of claim 1 further comprising:
the remote computing devices comprising:
a microphone for receiving sound and converting the sound into electronic signals for transmission to other of the remote computing devices; and
wherein the first processor further includes software which when executed by the first processor causes the server to identify those of the remote computing devices within a particular geographic area associated with the ongoing live event and to instruct the microphone for at least two of the remote computing devices within the particular geographic area to capture sound and to cause that sound to be transmitted to other of the remote computing devices in response to an occurrence within the ongoing live event.

5. The system of claim 4 wherein:
the server further comprises a geolocation system for receiving location information associated with each of the remote computing devices in communication with the server relative to the ongoing live event; and
wherein the first processor further includes software which when executed by the first processor causes the server to use the geolocation system to identify those of the remote computing devices within the particular geographic area associated with the ongoing live event.

6. The system of claim 5 wherein those of the remote computing devices within the particular geographic area operate in a contest separate from another contest for those outside of the particular geographic area.

7. The system of claim 1 further comprising
the remote computing devices comprising:
a camera for capturing images and sound and converting the images and sound into audiovisual data for transmission to others of the remote computing devices; and
wherein the first processor further includes software which when executed by the first processor causes the server to identify those of the remote computing devices within a particular geographic area associated with the ongoing live event and to instruct the camera for at least one of the remote computing devices within the particular geographic area to capture images and sound and to cause the audiovisual data to be transmitted to other of the remote computing devices in response to an occurrence within the ongoing live event.

8. The system of claim 7 wherein the at least one of the remote computing devices is selected based upon criteria selected from the group of: geolocation of the at least one of the remote computing devices, a compilation of outcomes predicted by a user for past live events, and payment of money or exchange of credits to be among the at least one of the remote computing devices for whom audiovisual data is captured.

9. A method of interactive fan engagement with live events comprising:
receiving updated event data relating to an ongoing live event using a communications interface of a server;
transmitting and receiving selection and status information with remote computing devices related to the ongoing live event using the communications interface;
storing the updated event data in a database at the server;
comparing the selection and status information with the updated event data using the server; and
identifying correct selections that occurred prior to a corresponding portion of the updated event data and user accounts associated with the correct selections using the server.

10. The method of claim 9 further comprising:
displaying the status information for the ongoing live event as received on a display of a remote computing device;
receiving selection information from a user identifying an expected outcome relating to the ongoing live event on a user interface of the remote computing device;
transmitting the selection information to the server using a second communications interface of the remote computing device; and
receiving status information identifying the correct selections as associated with a user account associated with the user.

11. The method of claim 10 further comprising receiving the selection from the user using the user interface and updating the display with an indication of a correct selection upon receipt of the status information from the server.

12. The method of claim 9 further comprising:
identifying remote computing devices within a particular geographic area associated with the ongoing live event;
instructing the microphone for at least two of the remote computing devices within the particular geographic area to capture sound;
receiving sound using a microphone and converting the sound into electronic signals using a processor for transmission to other of the remote computing devices; and
transmitting the electrical signals to other of the remote computing devices in response to an occurrence within the ongoing live event.

13. The method of claim 12 further comprising:
receiving location information associated with each of the remote computing devices from a geolocation system in communication with the server relative to the ongoing live event; and
identifying those of the remote computing devices within the particular geographic area associated with the ongoing live event using the geolocation system.

14. The method of claim 13 wherein those of the remote computing devices within the particular geographic area operate in a contest separate from another contest for those outside of the particular geographic area.

15. The method of claim 13 further comprising:
identifying the remote computing devices within the particular geographic area associated with the ongoing live event and to instruct the camera for at least one of the remote computing devices within the particular geographic area to capture images and sound;
capturing images and sound using a camera and converting the images and sound into audiovisual data for transmission to others of the remote computing devices; and
transmitting the audiovisual data to other of the remote computing devices in response to an occurrence within the ongoing live event.

16. The method of claim 15 wherein the at least one of the remote computing devices is selected based upon criteria selected from the group of: geolocation of the at least one of the remote computing devices, a compilation of outcomes predicted by a user for past live events, and payment of money or exchange of credits to be among the at least one of the remote computing devices for whom audiovisual data is captured.

17. A system for interactive fan engagement with live events comprising:
a server, including a first processor and first non-volatile memory, comprising:
a communications interface for receiving updated event data relating to an ongoing live event and for transmitting and receiving selection and status information with remote computing devices related to the ongoing live event;
a database for storing the updated event data; and
the first processor having software which when executed by the first processor:
compares the selection and status information with the updated event data and identifies correct selections that occurred prior to a corresponding portion of the updated event data;
identifies user accounts associated with the correct selections;
selects a subset of the user accounts for capture of audio and/or video in conjunction with the updated event data;
instructs the subset to capture audio and/or video in response to the updated event data;
receives captured audio and/or video; and
transmits the captured audio and/or video to other users of the system.

18. The system of claim 17 wherein the subset is selected based upon geographic information associated with the user accounts within the subset.

19. The system of claim 17 wherein the subset is selected based upon a monetary contribution made to the operator of the system.

20. The system of claim 17 wherein the subset is selected based upon self-reported affiliation with one or more participants in the ongoing live event.
